(19) United States
(12) Patent Application Publication
(10) Pub. No.: US 2025/0219482 A1
(43) Pub. Date: Jul. 3, 2025

(54) ROTOR OF A ROTATING ELECTRIC MACHINE AND ELECTROMAGNETIC RETARDER AND GENERATOR ASSEMBLY

(71) Applicant: TELMA, Saint-Ouen-L'aumone (FR)

(72) Inventors: Mbarek Akafou, Les Mureaux (FR); Romuald Belance, Deuil La Barre (FR); Nicolas Quennet, Cormeilles En Parisis (FR); Rafik Lounis, CERGY (FR)

(21) Appl. No.: 18/989,910

(22) Filed: Dec. 20, 2024

(30) Foreign Application Priority Data
Dec. 27, 2023 (FR) 2315350

(51) Int. Cl. H02K 1/22; H02K 9/22; H02K 49/00

(52) U.S. Cl. CPC H02K 1/22; H02K 9/227; H02K 49/00; H02K 2213/03

(57) ABSTRACT

A rotor of an electromagnetic retarder and generator assembly comprising: a central ring intended to be mounted around a rotary shaft; a cylindrical body having an inner face arranged facing the central ring, an outer face opposite the inner face, and a lateral fastening face, the cylindrical body being coaxial with the central ring; a fastening arm connected to the central ring and to the lateral fastening face of the cylindrical body; wherein the outer face of the cylindrical body comprises an edge adjacent to the lateral fastening face, termed the first edge and which comprises a slope inclined towards the axis of rotation.

### TECHNICAL FIELD OF THE INVENTION

The invention relates to a rotor of a rotating machine and in particular to a rotor of an electromagnetic retarder for a vehicle. The invention also relates to an electromagnetic retarder and generator assembly.

### BACKGROUND OF THE INVENTION

A rotor of an electromagnetic retarder and generator assembly comprising a central ring intended to be mounted on a rotary shaft, a lateral flange and a cylindrical body coaxial with the central ring is known. The flange consists of a ring-shaped plate that connects the inner ring to the cylindrical body. The cylindrical body constitutes the armature of the retarder.

Such a rotor is described in Patent Application FR 18 55 848 filed in the name of the applicant. However, the cylindrical body may deform after a large number of uses owing to the fact that it is subjected to high temperatures. It would be desirable to cool further the armature of this rotor.

It would be desirable to propose a rotor that does not deform over time under the effect of heat. It would be desirable to improve the cooling of the cylindrical body.

### BRIEF SUMMARY OF THE INVENTION

One subject of the present invention is a rotor of a rotating electric machine, in particular of an electromagnetic retarder for a vehicle, the rotor being able to rotate about an axis of rotation in a direction of rotation, the axis of rotation extending in an axial direction, the rotor comprising:
a central ring intended to be mounted around a rotary shaft;
a cylindrical body having an inner face arranged facing the central ring, an outer face opposite the inner face, and a lateral fastening face, the cylindrical body being coaxial with the central ring;
at least one fastening arm connected to the central ring and to the lateral fastening face of the cylindrical body,
   characterized in that the outer face of the cylindrical body comprises an edge adjacent to the lateral fastening face, termed the first edge; the first edge comprising a slope inclined towards the axis of rotation.

Advantageously, this slope makes it possible to increase the amount of air passing above the outer surface of the cylindrical body. The amount of air entering the cooling channels is increased. As the air has been introduced into the cooling channels through a wider opening, the speed of air flow through the cooling channels is increased.

The features described in the following paragraphs may optionally be implemented.

They may be implemented independently of one another or in combination with one another:
The slope is inclined at an angle of between 10 degrees and 30 degrees with respect to the axis of rotation.
The rotor further comprises a crown coaxial with the cylindrical body, the crown being arranged around the cylindrical body; the crown comprising a lateral end set back from the lateral fastening face in the axial direction, the lateral end of the crown being spaced apart from the lateral fastening face by a distance of greater than 15 millimetres, the distance being measured in the axial direction.
The slope has a width in the axial direction; and the width of the slope is greater than the distance between the lateral end and the lateral fastening face.
The rotor further comprises a plurality of first cooling fins arranged at least in part on the slope of the outer face of the cylindrical body, the first cooling fins being arranged parallel to one another along the first edge, the first cooling fins being curved and having a concavity oriented forwards when considering the direction of rotation of the rotor.
The outer face of the cylindrical body comprises a second edge opposite the first edge, and the rotor further comprises a plurality of second cooling fins arranged on part of the outer face of the cylindrical body, the second cooling fins being arranged parallel to one another along the second edge, the second cooling fins being curved and having a concavity oriented rearwards when considering the direction of rotation of the rotor.
At least part of the outer face of the cylindrical body comprises reliefs.
The reliefs comprise undulations; the undulations comprising a succession of circular recesses and rounded portions having as their centre a point on the axis of rotation X-X.

Another subject of the invention is an electromagnetic retarder and generator assembly, the assembly comprising a stator and a rotor; the stator comprising an outer face and an inner face; the outer face carrying a retarder inductor arranged facing an inner face of the cylindrical body; the inner face carrying a generator armature; the rotor being configured in accordance with the features mentioned above, the cylindrical body forming a retarder armature, the central ring comprising a generator inductor arranged facing the inner face of the stator.

### BRIEF DESCRIPTION OF THE FIGURES

FIG. 1 is a perspective view of part of a rotor according to the invention;

FIG. 2 is a view in radial section of the rotor illustrated in FIG. 1;

FIG. 3 is a schematic view of a section of the cylindrical body and of the crown, the cutting plane being a radial plane;

FIG. 4 is a plan view of part of the rotor illustrated in FIG. 1;

FIG. 5 is a schematic view in radial section of part of an electromagnetic retarder and generator assembly comprising a rotor illustrated in FIG. 1.

### DETAILED DESCRIPTION OF THE INVENTION

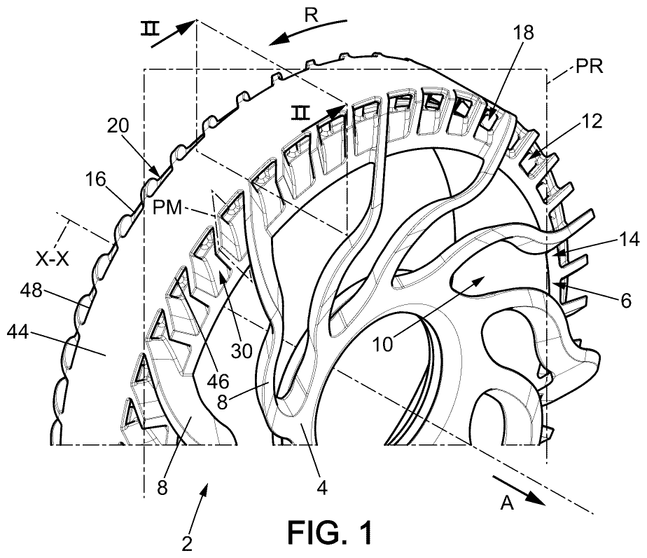

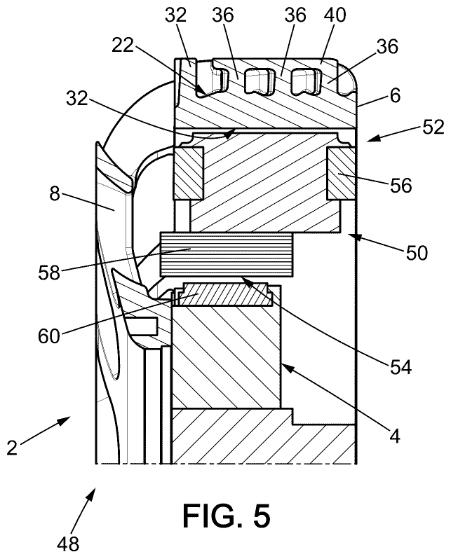

With reference to FIG. 1, the invention relates to a rotor 2 of a rotating electric machine. For example, the rotor 2 is a rotor of an electromagnetic retarder for a vehicle. In particular, this rotor may be mounted in an electromagnetic retarder and generator assembly as illustrated in FIG. 5.

The rotor 2 is able to rotate about an axis of rotation X-X extending in an axial direction A. For the purposes of the present description, a radial plane PR is defined as perpendicular to the axis of rotation X-X.

The rotor 2 comprises a central ring 4 intended to be fastened to a rotary shaft (not shown), a cylindrical body 6, and fastening arms 8 connected to the central ring and to the cylindrical body.

The central ring 4 and the cylindrical body 6 are coaxial.

The cylindrical body 6 comprises an inner face 10 arranged facing the central ring, an outer face 12 opposite the inner face, a lateral fastening face 14, and a lateral face 16 opposite the lateral fastening face.

In the example illustrated by way of non-limiting example, the rotor 2 comprises ten fastening arms. The fastening arms 8 are regularly distributed around the central ring.

The outer face 12 of the cylindrical body comprises an edge adjacent to the lateral fastening face, termed the first edge 18, and an edge arranged on the opposite side, termed the second edge 20.

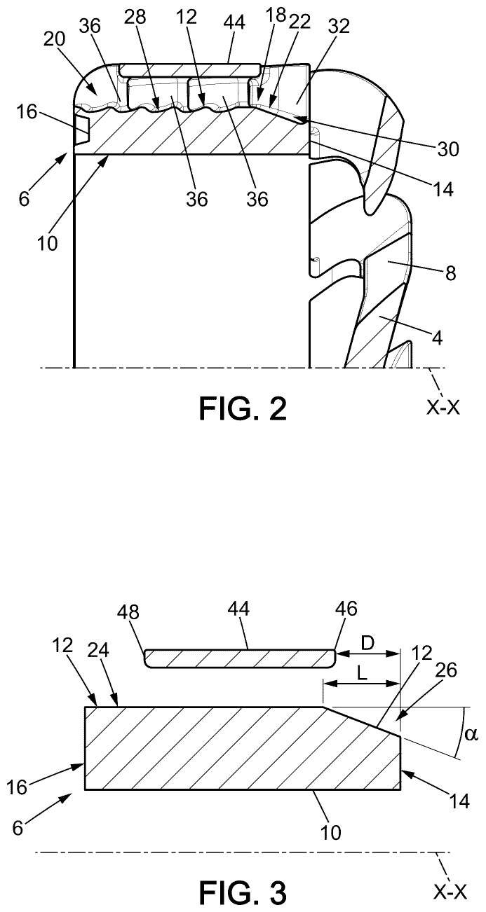

With reference to FIGS. 2 and 3, the first edge 18 comprises a slope 22 inclined towards the axis of rotation X-X.

The slope 22 is inclined at an angle α of between 10 degrees and 30 degrees with respect to the axis of rotation X-X.

The slope 22 has a width L in the axial direction A.

Thus, with reference to FIG. 3, the outer face 12 of the cylindrical body comprises a portion 24 having the general shape of a cylinder and a portion 26 having the shape of a truncated cone. The portion 26 in the shape of a truncated cone is adjacent to the lateral fastening face 14.

Advantageously, the slope 22 makes it possible to increase the amount of air passing above the outer surface of the cylindrical body. Consequently, the amount of air entering the cooling channels 30 is increased because the opening allowing the introduction of air is wider. As a greater amount of air is introduced into the cooling channels, the speed of air flow through the cooling channels is increased.

Preferably, the portion 24 having the general shape of a cylinder comprises reliefs 28, which are shown only in FIG. 2. In particular, in the embodiment illustrated by way of example, the reliefs 28 comprise undulations. The undulations comprise a succession of circular recesses and circular rounded portions having as their centre a point on the axis of rotation X-X.

According to a variant (not shown), the reliefs 28 comprise bosses, indentations or roughnesses.

Advantageously, these reliefs 28 create disturbances in the layer of air passing above the outer face of the cylindrical body. These disturbances make it possible to increase the cooling of the cylindrical body 6.

Advantageously, the portion 26 in the shape of a truncated cone, or in other words the slope 22, is smooth. It has no reliefs. This smooth surface makes it possible to increase the amount of air and the speed of the air entering the cooling channels 30.

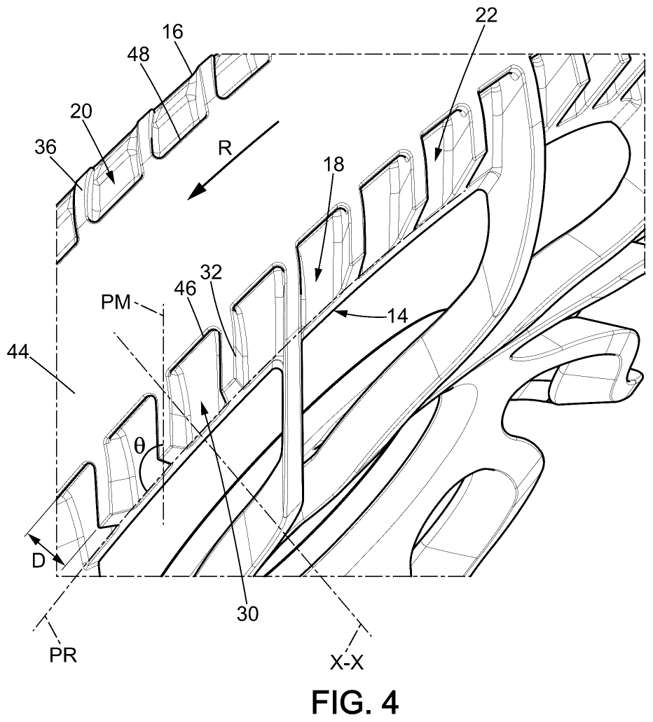

With reference to FIGS. 2 and 4, the cylindrical body 6 preferably comprises a plurality of first cooling fins 32 arranged at least in part on the slope 22 of the outer face 12 of the cylindrical body. The first cooling fins have a lamellar shape. The median plane PM of the first cooling fins 38 is oriented at an angle of between 40 degrees and 60 degrees with respect to the radial plane PR. Preferably, this angle θ (theta) is substantially equal to 45 degrees. The first cooling fins 32 are curved. They have a concavity oriented forwards when considering the direction of rotation R of the rotor. In other words, a vector normal to the concave face is directed in the direction of rotation R. The first cooling fins 32 are arranged parallel to one another. They are aligned and form a first row extending along the first edge 18.

Preferably, the cylindrical body 6 further comprises a plurality of second cooling fins 36 arranged on the cylindrical portion of the outer face of the cylindrical body. The second cooling fins 36 have a lamellar shape. The second cooling fins 36 are curved. They have a concavity oriented rearwards when considering the direction of rotation R of the rotor. In other words, a vector normal to the concave face is directed in a direction opposite to the direction of rotation R.

The second cooling fins 36 are arranged parallel to one another. The second cooling fins 36 are also parallel to the first cooling fins 32. They are aligned and form a second row which extends along the second edge 20.

In the non-limiting illustrated embodiment, the cylindrical body 6 comprises a third row and a fourth row of cooling fins 36, visible in FIG. 2. The cooling fins of the third row and of the fourth row are identical and oriented in the same way as the cooling fins 36 of the second row. In particular, their concave face is oriented in the same way as the cooling fins of the second row. They bear the same reference 36 and are not described again.

Preferably, the rotor 2 further comprises a crown 44 coaxial with the cylindrical body 6. The crown 44 is arranged around the cylindrical body. The crown 44 has a width smaller than the width of the cylindrical body. It is arranged above a central part of the cylindrical body. The crown 44 covers the cooling fins 36 of the third row, the cooling fins 36 of the fourth row, part of the cooling fins 32 of the first row and part of the cooling fins 36 of the second row. The cooling fins 32, 36 form cooling channels 30 with the crown 44, visible in FIG. 1.

The crown 44 comprises a first lateral end 46 situated on the lateral fastening face 14 side and a second lateral end 38 on the opposite side.

The first lateral end 46 is arranged set back in the axial direction A from the lateral fastening face 14 of the cylindrical body. The lateral end 46 of the crown is spaced apart from the lateral fastening face 14 by a distance D of greater than 15 millimetres. Preferably, this distance D is between 15 and 30 millimetres. This distance D is measured in the axial direction.

With reference to FIGS. 3 and 4, the slope 22 preferably has a width L in the axial direction A. The width L of the slope is greater than the distance D between the first lateral end 46 and the lateral fastening face 14.

In the non-limiting embodiment illustrated in the figures, the second lateral end 48 is also arranged set back in the axial direction A from the lateral face 16 of the cylindrical body.

With reference to FIG. 5, the invention also relates to an electromagnetic retarder and generator assembly 48. This assembly comprises a rotor 2 and a stator 50. The rotor 2 is configured in accordance with the features mentioned above.

The stator 50 comprises an outer face 52 and an inner face 54. The outer face 52 carries a retarder inductor 56 arranged facing an inner face 10 of the cylindrical body. The inner face 54 carries a generator armature 58. The cylindrical body 6 of the rotor 2 forms a retarder armature. The central ring 4 comprises a generator inductor 60 arranged facing the inner face 54 of the stator.

1. A rotor of a rotating electric machine, in particular of an electromagnetic retarder for a vehicle, the rotor being able to rotate about an axis of rotation in a direction of rotation, the axis of rotation extending in an axial direction, the rotor comprising:
a central ring intended to be mounted around a rotary shaft;
a cylindrical body having an inner face arranged facing the central ring, an outer face opposite the inner face, and a lateral fastening face, the cylindrical body being coaxial with the central ring; and
at least one fastening arm connected to the central ring and to the lateral fastening face of the cylindrical body, wherein the outer face of the cylindrical body comprises an edge adjacent to the lateral fastening face, termed the first edge; and wherein the first edge comprises a slope inclined towards the axis of rotation.

2. The rotor according to claim 1, wherein the slope is inclined at an angle of between 10 degrees and 30 degrees with respect to the axis of rotation.

3. The rotor according to claim 1, which further comprises a crown coaxial with the cylindrical body, the crown being arranged around the cylindrical body; the crown comprising a lateral end set back from the lateral fastening face in the axial direction, the lateral end of the crown being spaced apart from the lateral fastening face by a distance of greater than 15 millimetres, the distance being measured in the axial direction.

4. The rotor according to claim 3, wherein the slope has a width in the axial direction; and wherein the width of the slope is greater than the distance between the lateral end and the lateral fastening face.

5. The rotor according to claim 1, which further comprises a plurality of first cooling fins arranged at least in part on the slope of the outer face of the cylindrical body, the first cooling fins being arranged parallel to one another along the first edge, the first cooling fins being curved and having a concavity oriented forwards when considering the direction of rotation of the rotor.

6. The rotor according to claim 5, wherein the outer face of the cylindrical body comprises a second edge opposite the first edge, and wherein the rotor further comprises a plurality of second cooling fins arranged on part of the outer face of the cylindrical body, the second cooling fins being arranged parallel to one another along the second edge, the second cooling fins being curved and having a concavity oriented rearwards when considering the direction of rotation of the rotor.

7. The rotor according to claim 1, wherein at least part of the outer face of the cylindrical body comprises reliefs.

8. The rotor according to claim 7, wherein the reliefs comprise undulations; the undulations comprising a succession of circular recesses and rounded portions having as their centre a point on the axis of rotation.

9. An electromagnetic retarder and generator assembly comprising a stator and a rotor; the stator comprising an outer face and an inner face; the outer face carrying a retarder inductor arranged facing an inner face of the cylindrical body; the inner face carrying a generator armature; the rotor being configured in accordance with claim 1, the cylindrical body forming a retarder armature, the central ring comprising a generator inductor arranged facing the inner face of the stator.
